(19) United States
(12) Patent Application Publication
(10) Pub. No.: US 2003/0007666 A1
(43) Pub. Date: Jan. 9, 2003

(54) Method and apparatus for relief texture map flipping

(76) Inventors: James A. Stewartson, Oakland, CA (US); David Westwood, Palo Alto, CA (US); Hartmut Neven, Santa Monica, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/238,289

(22) Filed: Sep. 9, 2002

Related U.S. Application Data
(63) Continuation of application No. 09/724,320, filed on Nov. 27, 2000.
Application No. 09/724,320 is a continuation-in-part of application No. 09/188,079, filed on Nov. 6, 1998, now Pat. No. 6,272,231.
(60) Provisional application No. 60/081,615, filed on Apr. 13, 1998.

(51) Int. Cl. G06K 9/00

(52) U.S. Cl. 382/103

(57) ABSTRACT

The present invention is embodied in a method and apparatus for relief texture map flipping. The relief texture map flipping technique provides realistic avatar animation in a computationally efficient manner.

### CROSS-REFERENCE TO RELATED APPLICATIONS

This a continuation-in-part of U.S. patent application Ser. No. 09/188,079, entitled WAVELET-BASED FACIAL MOTION CAPTURE FOR AVATAR ANIMATION and filed Nov. 6, 1998. The entire disclosure of U.S. patent application Ser. No. 09/188,079 is incorporated herein by reference.

### BACKGROUND OF THE INVENTION

The present invention relates to avatar animation, and more particularly, to remote or delayed rendering of facial features on an avatar.

Virtual spaces filled with avatars are an attractive way to allow for the experience of a shared environment. However, animation of a photo-realistic avatar generally requires intensive graphic processes, particularly for rendering facial features.

Accordingly, there exists a significant need for improved rendering of facial features. The present invention satisfies this need.

### SUMMARY OF THE INVENTION

The present invention is embodied in a method, and related apparatus, for animating facial features of an avatar image using a plurality of image patch groups. Each patch group is associated with a predetermined facial feature and has a plurality of selectable relief textures. The method includes sensing a person's facial features and selecting a relief texture from each patch group based on the respective sensed facial feature. The selected relief textures are then warped to generate warped textures. The warped textures are then texture mapped onto a target image to generate a final image.

The selectable relief textures are each associated with a particular facial expression. A person's facial features may be sensed using a Gabor jet graph having node locations. Each node location may be associated with a respective predetermined facial feature and with a jet. Each relief texture may include a texture having texels, each extended with an orthogonal displacement. The orthogonal displacement per texel may be automatically generated using Gabor jet graph matching on images provided by at least two spaced-apart cameras.

Other features and advantages of the present invention should be apparent from the following description of the preferred embodiments taken in conjunction with the accompanying drawings, which illustrate, by way of example, the principles of the invention.

### BRIEF DESCRIPTION OF THE DRAWINGS

FIG. 1 is a flow diagram showing the generation of a tagged personalized Gabor jet graph along with a corresponding gallery of image patches that encompasses a variety of a person's expressions for avatar animation, according with the invention.

FIG. 2 is a flow diagram showing a technique for animating an avatar using image patches that are transmitted to a remote site, and that are selected at the remote site based on transmitted tags based on facial sensing associated with a person's current facial expressions.

FIG. 3 is a schematic diagram of an image graph of Gabor jets, according to the invention.

FIG. 4 is a schematic diagram of a face with extracted eye and mouth regions.

FIG. 5 is a flow diagram showing a technique for relief texture mapping, according to the present invention.

### DETAILED DESCRIPTION OF THE PREFERRED EMBODIMENTS

The present invention is embodied in a method and apparatus for relief texture map flipping. The relief texture map flipping technique provides realistic avatar animation in a computationally efficient manner.

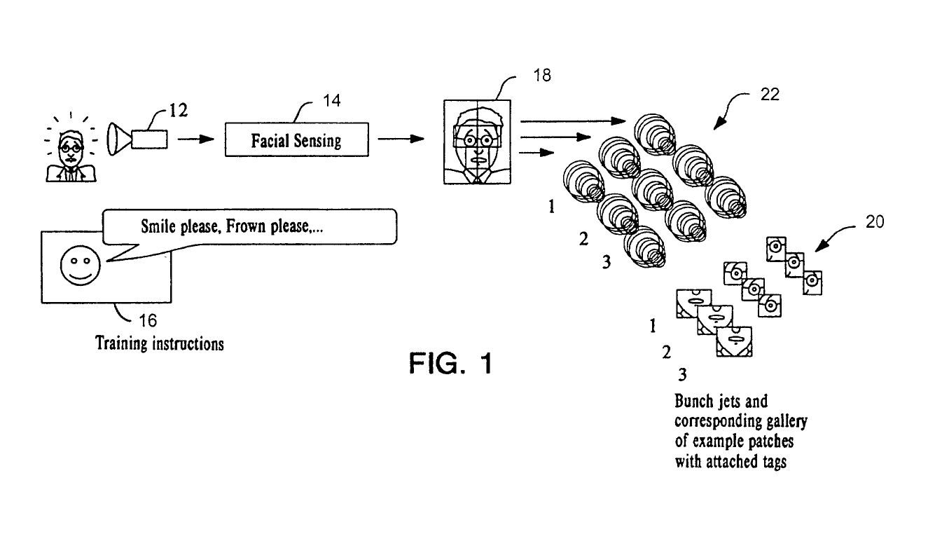

With reference to FIG. 1, an imaging system 10 acquires and digitizes a live video image signal of an individual thus generating a stream of digitized video data organized into image frames (block 12). The digitized video image data is provided to a facial sensing process (block 14) which automatically locates the individual's face and corresponding facial features in each frame using Gabor jet graph matching. The facial sensing process also tracks the positions and characteristics of the facial features from frame-to-frame. Facial feature finding and tracking using Gabor jet graph matching is described in U.S. patent application Ser. No. 09/188,079. Nodes of a graph are automatically placed on the front face image at the locations of particular facial features.

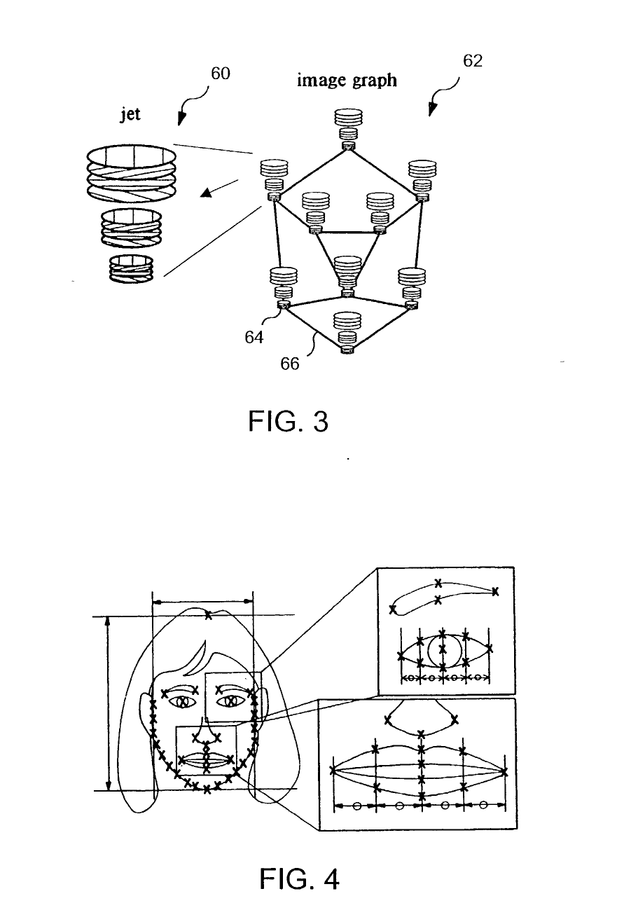

A jet 60 and a jet image graph 62 is shown in FIG. 3. The jets are composed of wavelet transforms processed at node or landmark locations on an image corresponding to readily identifiable features. A wavelet centered at an image position of interest is used to extract a wavelet component from the image. Each jet describes the local features of the area surrounding the image point. If sampled with sufficient density, the image may be reconstructed from jets within the bandpass covered by the sampled frequencies. Thus, each component of a jet is the filter response of a Gabor wavelet extracted at a point (x, y) of the image.

The space of wavelets is typically sampled in a discrete hierarchy of 5 resolution levels (differing by half octaves) and 8 orientations at each resolution level, thus generating 40 complex values for each sampled image point (the real and imaginary components referring to the cosine and sine phases of the plane wave). For graphical convenience, the jet 60 shown in FIG. 3 indicates 3 resolution levels, each level having 4 orientations.

A labeled image graph 62, as shown in FIG. 3, is used to sense the facial features. The nodes 64 of the labeled graph refer to points on the object and are labeled by jets 60. Edges 66 of the graph are labeled with distance vectors between the nodes. Nodes and edges define the graph topology. Graphs with equal topology can be compared. The normalized dot product of the absolute components of two jets defines the jet similarity. This value is independent of contrast changes. To compute the similarity between two graphs, the sum is taken over similarities of corresponding jets between the graphs. Thus, the facial sensing may use jet similarity to determine the person's facial features and characteristics.

As shown in FIG. 4, the facial features corresponding to the nodes may be classified to account for blinking, mouth opening, etc. Labels are attached to the different jets in the bunch graph corresponding the facial features, e.g., eye, mouth, etc.

During a training phase, the individual is prompted for a series of predetermined facial expressions (block 16), and sensing is used to track the features (block 18). At predetermined locations, jets and image patches are extracted for the various expressions. Image patches 20 surrounding facial features are collected along with the jets 22 extracted from these features. These jets are used later to classify or tag facial features. This process is performed by using these jets to generate a personalized bunch graph of image patches, or the like, and by applying the classification method described above.

Preferably, the image patches are relief textures having texels each extended with orthogonal displacement. The relief textures may be automatically generated during an authoring process by capturing depth information using Gabor jet graph matching on images provided by stereographic cameras. A technique for automated feature location is described in U.S. provisional application Ser. No. 60/220,309, “SYSTEM AND METHOD FOR FEATURE LOCATION AND TRACKING IN MULTIPLE DIMENSIONS INCLUDING DEPTH” filed Jul. 24, 2000, which application is incorporated herein by reference. Other systems may likewise automatically provide depth information.

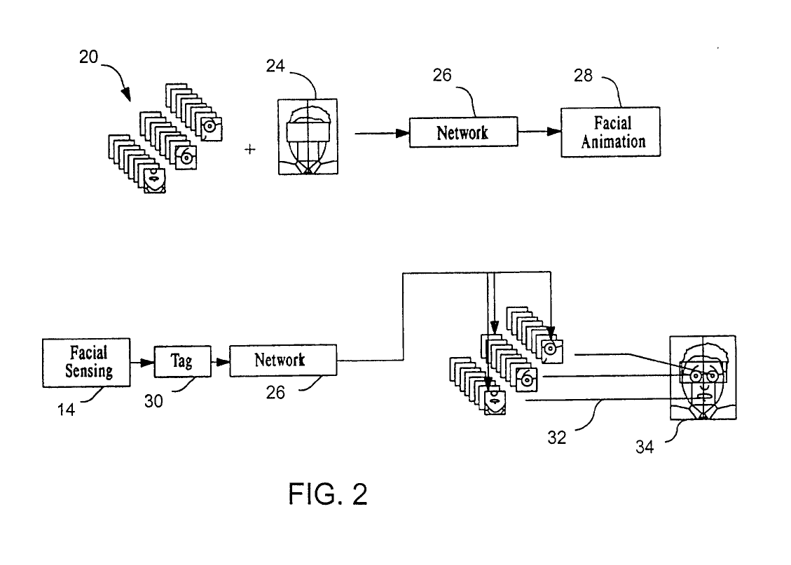

As shown in FIG. 2, for animation of an avatar, the system transmits all image patches 20, as well as the image of the whole face 24 (the “face frame”) minus the parts shown in the image patches over a network to a remote site (blocks 26 & 28). The software for the animation engine also may need to be transmitted. The sensing system then observes the user's face and facial sensing is applied to determine which of the image patches is most similar to the current facial expression. Image tags 30 are transmitted to the remote site allowing the animation engine to assemble the face 34 using the correct image patches.

Thus, the reconstructed face in the remote display may be composed by assembling pieces of images corresponding to the detected expressions in the learning step. Accordingly, the avatar exhibits features corresponding to the person commanding the animation. Thus, at initialization, a set of cropped images corresponding to each tracked facial feature and a “face container” as the resulting image of the face after each feature is removed. The animation is started and facial sensing is used to generate specific tags which are transmitted as described previously. Decoding occurs by selecting image pieces 32 associated with the transmitted tag 30, e.g., the image of the mouth labeled with a tag “smiling-mouth”.

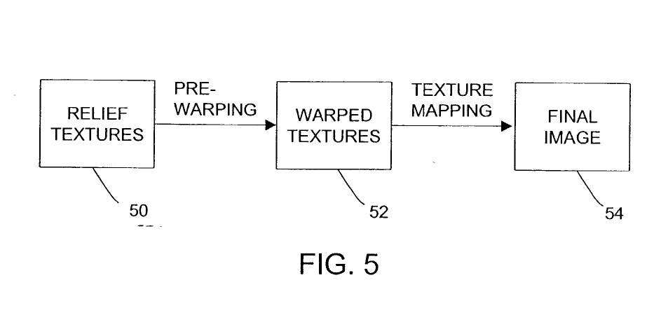

A more advanced level of avatar animation may be reached when the aforementioned dynamic texture generation is integrated with relief texture mapping as shown in FIG. 5. A relief texture 50 is a texture extended with orthogonal displacements per texel. The rendering techniques may generate very realistic views by pre-warping relief texture images to generate warped textures 52 and then performing conventional texture mapping to generate a final image 54. The pre-warping should be factored so to allow conventional texture mapping to be applied after warping by shifting the direction of an epipole. The pre-warp may be implemented using 1-D image operations along rows and columns, requiring interpolation between only two adjacent texels at a time. This property greatly simplifies the tasks of reconstruction and filtering of the intermediate image and allows a simple and efficient hardware implementation. During the warp, texels move only horizontally and vertically in texture space by amounts that depend on their orthogonal displacements and on the viewing configuration. The warp implements no rotations.

Pre-warping of the relief textures determines the coordinates of infinitesimal points in the intermediate image from points in the source image. Determining these is the beginning of the image-warping process. The next step is reconstruction and resampling onto the pixel grid of an intermediate image. The simplest and most common approaches to reconstruction and resampling are splatting and meshing. Splatting requires spreading each input pixel over several output pixels to assure full coverage and proper interpolation. Meshing requires rasterizing a quadrilateral for each pixel in the N×N input texture.

Reconstruction and resampling as a two-pass process using 1-D transforms along rows and columns. Such phases consist of a horizontal pass and a vertical pass. Assuming that the horizontal pass takes place first, the first texel of each row is moved to its final column and, as the subsequent texels are warped, color and final row coordinates are interpolated during rasterization. Fractional coordinate values (for both rows and columns) are used for filtering purposes in a similar way as described. During the vertical pass, texels are moved to their final row coordinates and colors are interpolated.

Relief textures can be used as modeling primitives by simply instantiating them in a scene in such a way that the respected surfaces match the surfaces of the objects to be modeled. During the pre-warp, however, samples may have their coordinates mapped beyond the limits of the original texture. This corresponds, in the final image, to have samples projecting outside the limits of the polygon to be texture-mapped. Techniques for implementing relief texture mapping are described in a paper: Oliveira et al., “Relief Texture Mapping”, SIGGRAPH 2000, Jul. 23-28, 2000, pages 359-368.

To fit the image patches smoothly into the image frame, Gaussian blurring may be employed. For realistic rendering, local image morphing may be needed because the animation may not be continuous in the sense that a succession of images may be presented as imposed by the sensing. The morphing may be realized using linear interpolation of corresponding points on the image space. To create intermediate images, linear interpolation is applied using the following equations:

Pᵢ=(2−i)P₁+(i−1)P₂ (7)

Pᵢ=(2−i)P₁+(i−1)I₂ (8)

where P₁ and P₂ are corresponding points in the images I₁ and I₂, and Iᵢ is the i^{th} interpolated image with 1 I 2. Note that for process efficient, the image interpolation may be implemented using a pre-computed hash table for Pᵢ and Iᵢ. The number and accuracy of points used, and their accuracy, the interpolated facial model generally determines the resulting image quality.

Although the foregoing discloses the preferred embodiments of the present invention, it is understood that those skilled in the art may make various changes to the preferred embodiments without departing from the scope of the invention. The invention is defined only the following claims.

We claim:

1. A method for animating facial features of an avatar image using a plurality of image patch groups, each patch group being associated with a predetermined facial feature and having a plurality of selectable relief textures, comprising:
sensing a person's facial features;
selecting a relief texture from each patch group based on the respective sensed facial feature;
warping the selected relief textures to generate warped textures;
texture mapping the warped textures onto a target image to generate a final image.

2. A method for animating facial features of an avatar image as defined in claim 1, wherein the selectable relief textures are each associated with a particular facial expression.

3. A method for animating facial features of an avatar image as defined in claim 1, wherein the step of sensing a person's facial features is performed using a Gabor jet graph having node locations, wherein each node location is associated with a respective predetermined facial feature and with a jet.

4. A method for animating facial features of an avatar image as defined in claim 1, wherein each relief texture includes a texture having texels each extended with an orthogonal displacement.

5. A method for animating facial features of an avatar image as defined in claim 4, further comprising automatically generating the orthogonal displacement per texel using Gabor jet graph matching on images provided by at least two spaced-apart cameras.

6. Apparatus for animating facial features of an avatar image using a plurality of image patch groups, each patch group being associated with a predetermined facial feature and having a plurality of selectable relief textures, comprising:
means for sensing a person's facial features;
means for selecting a relief texture from each patch group based on the respective sensed facial feature;
means for warping the selected relief textures to generate warped textures;
means for texture mapping the warped textures onto a target image to generate a final image.

7. Apparatus for animating facial features of an avatar image as defined in claim 6, wherein the selectable relief textures are each associated with a particular facial expression.

8. Apparatus for animating facial features of an avatar image as defined in claim 6, wherein the means for sensing a person's facial features uses a Gabor jet graph having node locations, wherein each node location is associated with a respective predetermined facial feature and with a jet.

9. Apparatus for animating facial features of an avatar image as defined in claim 6, wherein each relief texture includes a texture having texels each extended with an orthogonal displacement.

10. Apparatus for animating facial features of an avatar image as defined in claim 9, further comprising means for automatically generating the orthogonal displacement per texel using Gabor jet graph matching on images provided by at least two spaced-apart cameras.
